(19) United States
(12) Patent Application Publication
(10) Pub. No.: US 2009/0017755 A1
(43) Pub. Date: Jan. 15, 2009

(54) INFORMATION COMMUNICATION DEVICE

(75) Inventor: Masaaki TOMODA, Osaka (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Osaka (JP)

(21) Appl. No.: 12/147,141

(22) Filed: Jun. 26, 2008

(30) Foreign Application Priority Data
Jul. 3, 2007 (JP) 2007-175350

(51) Int. Cl. H04B 7/00

(52) U.S. Cl. 455/41.2

(57) ABSTRACT

In the information communication device of the present invention, the first device and the second device are arranged to be connected by wired and exchange device information with each other, as a result of which the first device and the second device can be placed into a state permitting Bluetooth-based wireless communication between the two even without performing a Bluetooth pairing process. Accordingly, the user can enable Bluetooth-based wireless communication simply by inserting the portable audio device 2, i.e. the second device, into the slot 3 in the audio system 1, i.e. the first device, which allows operability to be improved.

### BACKGROUND OF THE INVENTION

1. Field of the Invention

The present invention relates to an information communication device adapted to wireless communication.

2. Description of Related Art

In recent years, the use of wireless telecommunication connections has been increasing rapidly for the purposes of controlling, as well as exchanging information between, various information devices such as mobile phone handsets, personal computers, etc. Such wireless telecommunication connection systems are not limited to public telecommunication lines and are used also in local wireless communication systems such as Bluetooth (registered trademark) and Wireless LANs (Local Area Networks). A configuration of a Bluetooth communication system is disclosed in Patent document 1 (JP2003-224567A).

A Bluetooth communication system assigns the roles of a “master” and “slaves” to communicatively connected devices. A “master” can control the local wireless communication system. “Slaves” can join the local wireless communication system and communicate with the master. A Bluetooth communication system is a packet-switched local wireless communication system.

The security of a Bluetooth communication system is managed based upon the concept of “link keys”. “Link keys” are parameters used to manage 1-on-1 security for a particular pair of handsets. Namely, if shared parameters have not been set for two handsets, such as a predetermined master and a slave belonging to its piconet (a small-scale master-centered network formed by a master and a slave or slaves), communication over the user's logical channel is impossible. It is understood that the link keys must not be disclosed to a third party. Direct communication between the slaves in a piconet is impossible. Accordingly, no link keys are defined between the slaves.

For each Bluetooth handset, pairs of Bluetooth addresses and link keys for all its authenticated communication partners are held in a database.

In a Bluetooth communication system, there are provided four types of link keys, which are employed differently depending on the intended use and purpose. The above-mentioned four types of link keys include an “initialization key”, a “unit key”, a “combination key”, and a “master key”, with each of the link keys having a fixed 128-bit length. In a Bluetooth communication system, these four types of link keys collectively are referred to as “link keys”.

The role played by the link keys in the security of a Bluetooth communication system resides in registering security parameters in a database, making decisions regarding authentication based on the configured parameters, and generating encryption keys necessary for processing used to ensure confidentiality.

An initialization key is a link key utilized by Bluetooth handsets attempting to establish a connection for the first time. Despite the fact that it plays the role of a security management parameter, it is treated as a temporary link key, and the initialization key itself is not recorded in the database.

A unit key or a combination key is configured as a genuine link key used as a parameter in the database. When a link key is recorded in the database as an official parameter, the initialization key is discarded.

In order to generate an initialization key, a passkey (similar to a PIN code (PIN: Personal Identification Number)) from a higher-level application and a random number internally generated by the Bluetooth handset receiving a connection request are entered as parameters.

The important point here is that when the initialization key is computed, the passkey is entered separately on each Bluetooth handset. While the 128-bit random number internally generated on one handset is transmitted to another handset and mutually shared, a passkey is entered by each application independently. The above-mentioned two items are used as input for an initialization key algorithm, which computes the initialization key.

In a Bluetooth communication system, passkey entry is regarded as essential in preventing misconnection to unauthenticated handsets. Moreover, the connection security of the users' logical channels is ensured by entering the same passkey separately on each handset. It should be noted that, depending on the type of the product, passkey entry may be eliminated either on one or on both devices.

FIG. 5 illustrates the configuration of a conventional audio system adapted to the Bluetooth communication system. In addition to means permitting playback of musical data recorded on disk-shaped media and the like, the audio system 101 has built-in means permitting Bluetooth protocol-compliant wireless communication with the portable audio device 102. Also, in addition to means permitting playback of musical data recorded on a removable memory card or built-in memory, the portable audio device 102 has built-in means permitting Bluetooth protocol-compliant wireless communication with the audio system 101. For instance, if the audio system 101 is a transmitting device and the portable audio device 102 is connected as a receiving device, then an audio signal played back by the audio system 101 can be transmitted wirelessly to the portable audio device 102 and audio based on the audio signal can be outputted from headphones connected to the portable audio device 102. Moreover, if the audio system 101 is a receiving device and the portable audio device 102 is connected as a transmitting device, then an audio signal played back by the portable audio device 102 can be transmitted wirelessly to the audio system 101 and audio based on the audio signal can be outputted from loudspeakers connected to the audio system 101. In order to place the audio system 101 and the portable audio device 102 in a wireless communication-enabled state, a pairing process needs to be performed in order to inform each other of the respective communication-enabled state.

FIG. 6 shows an outline of the pairing process in a Bluetooth communication system. First of all, the portable audio device 102 is operated to transition the portable audio device 102 into a pairing standby mode (pairing-enabled state) (S101). Subsequently, a search for wireless communication-enabled devices (S102) is carried out by operating the audio system 101.

When the audio system 101 recognizes the presence of the portable audio device 102, the audio system 101 acquires Bluetooth address information and Bluetooth device name information from the portable audio device 102. Next, based on the device search results, the audio system 101 displays a list of devices currently enabled for wireless communication (with address information and device name information for all the devices) on a display unit 103 (S103). If at such time there are multiple devices enabled for Bluetooth protocol-compliant wireless communication in the audio system 101, all or some of them are displayed on the display unit 103.

Subsequently, a device with which it is desirable to establish wireless communication is selected by operating a user input unit (not shown) on the audio system 101 while reviewing the list displayed on the display unit 103 (S104). At this point, the portable audio device 102 requests passkey entry from the audio system 101.

Next, a passkey is entered by operating the audio system 101 (S105).

Subsequently, the audio system 101 generates a link key based on the entered passkey. In addition, the portable audio device 102 generates a link key based on its own passkey. It should be noted that the link key generated in the audio system 101 is the same as the link key generated in the portable audio device 102 (S106).

Next, setup processing is performed in the audio system 101 and the portable audio device 102. Specifically, the link key generated in the audio system 101 is stored in the database of the audio system 101 along with the address information and device name information of the portable audio device 102. Moreover, the link key generated in the portable audio device 102 is stored in its own database along with the address information and device name information of the audio system 101 (S107).

As a result of the above, the process of pairing the audio system 101 and the portable audio device 102 is completed, resulting in mutual device authentication.

The next time, the thus paired devices can transition immediately to a wireless communication-enabled state by referring to the information in the databases because once the pairing process is completed, mutual device information is stored in the databases.

However, the problem with the configuration disclosed in Patent document 1 is that the device pairing process requires an extended time (typically about 2 to 3 minutes), which decreases the ease of use. Furthermore, in order to pair devices, the user is required to perform the operation of device selection (S104) and the operation of passkey entry (S105), which decreases operability.

### SUMMARY OF THE INVENTION

It is an object of the present invention to provide an information communication device capable of improving the ease of use and operability while maintaining security by eliminating user passkey entry and shortening the time to authentication during device pairing.

The information communication device of the present invention includes a wireless communication unit capable of wireless communication with another information communication device via short-range wireless communication; a wired communication unit capable of wired communication with the other information communication device; a storage unit that stores first device information transferred from the other information communication device via the wired communication unit along with storing second device information concerning this device; and a control unit that controls all the units. The control unit, upon connection of the wired communication unit to the other information communication device, reads the second device information from the storage unit and control to transfer the second device information to the other information communication device via the wired communication unit and control to store the first device information transferred via the wired communication unit from the other information communication device in the storage unit, and when wireless communication is effected using the wireless communication unit, performs communication connection authentication based on the first device information stored in the storage unit.

By permitting elimination of authentication code (e.g. passkey) entry by the user along with shortening the time to mutual device authentication when transitioning to a state, in which the devices can communicate with each other wirelessly, the present invention makes it possible to maintain security while improving the ease of use and operability.

### BRIEF DESCRIPTION OF THE DRAWINGS

FIG. 1 is a perspective view illustrating an exemplary information communication device according to an embodiment.

FIG. 2 is a block diagram illustrating the configuration of the information communication device according to the embodiment.

FIG. 3 is a flow chart illustrating the operation of the information communication device according to Embodiment 1.

FIG. 4 is a flow chart illustrating an example of the operation of an information communication device according to Embodiment 2.

FIG. 5 is a perspective view illustrating the configuration of a conventional information communication device.

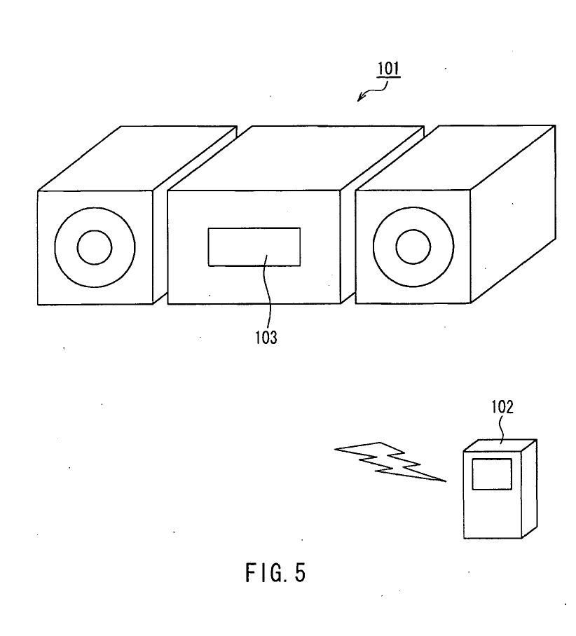

FIG. 6 is a flow chart illustrating the Bluetooth pairing process sequence.

### DETAILED DESCRIPTION OF THE INVENTION

The information communication device of the present invention includes a wireless communication unit capable of wireless communication with another information communication device via short-range wireless communication; a wired communication unit capable of wired communication with the other information communication device; a storage unit that stores first device information and second device information, the first device information is transferred from the other information communication device via the wired communication unit, and the second device information is concerning this device; and a control unit controlling all the units. The control unit, upon connection of the wired communication unit to the other information communication device, reads the second device information from the storage unit and control to transfer the second device information to the other information communication device via the wired communication unit, and control to store the first device information transferred via the wired communication unit from the other information communication device in the storage unit, and when wireless communication is effected using the wireless communication unit, performs communication connection authentication based on the first device information stored in the storage unit.

Based on the above-described configuration, the information communication device of the present invention can assume various embodiments, which are shown below.

Namely, in the information communication device of the present invention, the first device information and the second device information can be arranged to include at least the address information used for wireless communication between the devices. Such a configuration permits a reduction in the amount of information transferred between the devices.

Moreover, the first device information and the second device information can be arranged to include the device address information and information required for link key generation. Such a configuration permits a reduction in the number of entry operations and allows for operability to be improved because the process of entering passkeys, which was required in the past, is rendered unnecessary. Furthermore, service information and device name information can be sent as well, and such a configuration permits user identification of devices available for connection and easy classification of devices when there are numerous devices listed.

### EMBODIMENT 1

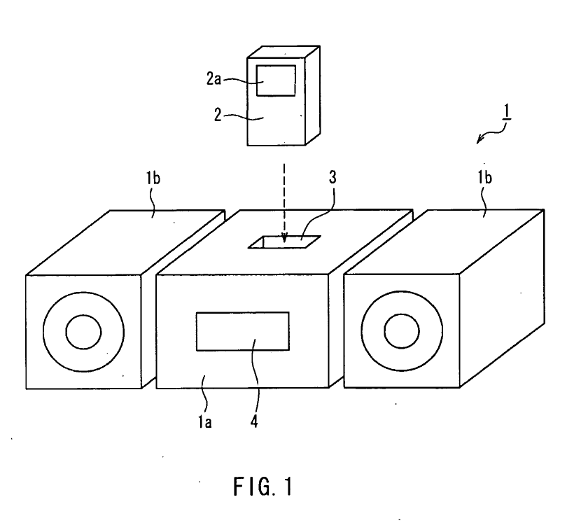

FIG. 1 illustrates an exemplary information communication device according to an embodiment. As shown in FIG. 1, in the present embodiment, an audio system 1 and a portable audio device 2 are used as examples of information communication devices, but a combination of other devices can be used as well. Examples of such other devices include mobile phone handsets and hands-free devices that combine headphones and a microphone. Furthermore, although in the present embodiment the audio system 1 and portable audio device 2 are constituted by devices capable of both transmitting and receiving information, they also may be constituted by devices, either one of which is capable only of receiving or only of transmitting (headphones, microphone, etc.).

The audio system 1 is composed of a main body 1a, which includes an element capable of playing back and outputting musical data recorded on disk-shaped media and other information media, and a dual speaker system 1b comprising loudspeakers capable of outputting audio signals generated based on the musical data in the main body 1a. A slot 3, which allows for insertion and removal of the portable audio device 2, is provided, for instance, on the top face of the main body 1a. Inside the slot 3, there is provided a connection terminal that permits connection to a connection terminal provided on the portable audio device 2. Moreover, a display unit 4, which allows various types of information to be displayed, such as song titles and the like, is provided, for example, on the front face of the main body 1a. It should be noted that while the present invention can be implemented without providing the display unit 4, providing the display unit 4 allows for the ease of use to be improved because the various types of information can be recognized visually by the user. In addition, the audio system 1 includes means permitting wireless communication, such as a Bluetooth communication system etc.

The portable audio device 2 is a device that can play back musical data recorded in a built-in memory or on a removable memory card and can output an analog audio signal to the headphones or other sound output devices connected thereto. In addition, the portable audio device 2 includes a connection terminal, which is, for instance, on the bottom of the housing. Furthermore, a display unit 2a capable of displaying various types of information, such as song titles and the like, is provided on the side of the main body. In addition, the portable audio device 2 includes an element permitting wireless communication, such as Bluetooth, etc. It should be noted that while in the present embodiment the audio system 1 and portable audio device 2 are arranged to include an element permitting Bluetooth-based wireless communication, at least as long as there is an element that permit wireless communication between the audio system 1 and portable audio device 2, the elements that permit wireless communication are not limited to Bluetooth and also may include Wireless LANs, etc.

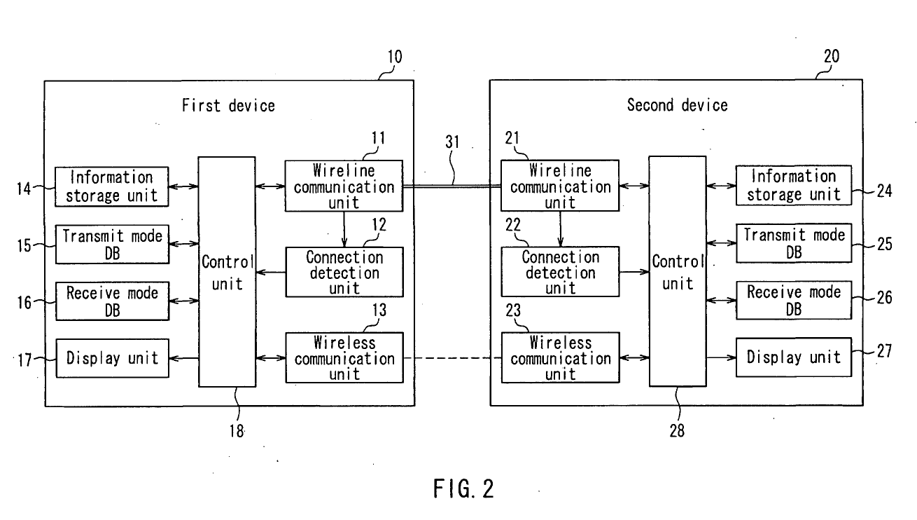

FIG. 2 illustrates the configuration of the information communication system in detail. In FIG. 2, the first device 10 corresponds to the audio system 1 of FIG. 1. Moreover, the second device 20 corresponds to the portable audio device 2 of FIG. 1. It should be noted that FIG. 2 shows only the communication element of each device while omitting other elements (for playing back musical data, etc.). Moreover, since in the present embodiment both the first device 10 and the second device 20 are constituted by devices capable of transmission and reception, the components they include as communication elements are the same. Therefore, explanations are given only for components provided in the first device 10.

The wired communication unit 11 is composed of a connector disposed in the slot 3 and a signal processing circuit, etc., which exercises operational control over, and generates signals for wired communication. The wired communication unit 11 can establish wired communication between the first device 10 and the second device 20 by connecting to the wired communication unit 21 of the second device 20 through the pathway 31. Moreover, in the present embodiment, electric power can be supplied from the first device 10 to the second device 20 via the wired communication unit 11 and pathway 31.

The connection detection unit 12 detects connection of the wired communication unit 21 to the wired communication unit 11. The detection results are transferred to the control unit 18. It should be noted that the connection detection unit 12 (and 22) is not an essential component and a configuration may be used in which the wired communication unit 11 is provided with a feature for recognizing connection of the second device 20 to the wired communication unit 11.

The wireless communication unit 13 effects wireless communication with the wireless communication unit 23 of the second device 20. The wireless communication unit 13 includes an antenna, an oscillator circuit, etc. In the present embodiment, the wireless communication unit 13 includes communication element corresponding to the Bluetooth communication system.

Information concerning the first device 10 is stored in the information storage unit 14 in advance. Examples of the information stored in the information storage unit 14 include address information, device name information, service name information (profiles), etc. The term “device name information”, as used herein, refers to information such as the product name and model name of the first device 10. Moreover, the term “service name information” refers to profile information concerning the first device 10. For instance, in the case of an audio device, the service name information is set to “AUDIO (with a transmitter/receiver distinction)”, and in case of a hands-free handset, “HANDS-FREE” or “PHONE”.

The transmit mode database 15 (referred to as “transmit mode DB” below) stores information on other devices, to which the first device 10 can be connected (authenticated for wireless communication) while in the transmit mode. The transmit mode DB 15 stores information regarding which devices are in the receive mode among the devices other than the first device 10. In addition, the receive mode database 16 (referred to as “receive mode DB” below) stores information on other devices, to which the first device 10 can be connected while in the receive mode. The transmit mode DB 16 stores information regarding which devices are in the transmit mode among the devices other than the first device 10. For instance, when, as illustrated in FIG. 1, the first device 10 is an audio system and the second device 20 is a portable audio device, both devices has the transmit mode and the receive mode, which makes authentication of wireless communication necessary both in the transmit mode and in the receive mode. When both devices complete wireless communication authentication in the transmit mode and in the receive mode, information related to the second device 20 is stored in the transmit mode DB 15 and receive mode DB 16. In addition, if the second device 20 has only receive mode, such as in case of headphones and the like, information related to the second device 20 is stored only in the transmit mode DB 15 in the first device 10.

It should be noted that while in the present embodiment the transmit mode DB 15 and receive mode DB 16 are provided separately, information used for transmission and information used for reception may be arranged to be stored in a single database. Moreover, assuming that e.g. the first device 10 is a transmitting device and the second device 20 is connected as a receiving device, an example of the contents of the transmit mode DB 15 of the first device 10 is shown in Table 1 and an example of the contents of the transmit mode DB 25 of the second device 20 is shown in Table 2.

TABLE 1

| Address | Link Key | Device Name | Service |
|---|---|---|---|
| A1 | L1 | SD Player | AUDIO (receiver) |

TABLE 2

| Address | Link Key | Device Name | Service |
|---|---|---|---|
| A3 | L3 | Micro Stereo Systems | AUDIO |
| A2 | L2 | Mobile phone | PHONE |

The display unit 17 can display song titles and the status of the first device 10. The display unit 17 corresponds to the display unit 4 in FIG. 1. It should be noted that while the display unit 17 is not essential, if it is provided, it can display information on the other connected devices and, as a result, the user readily can obtain information on the other devices and the ease of use can be improved.

The control unit 18 controls the operation of each unit in the first device 10.

It should be noted that while the information communication unit 14, transmit mode DB 15, and receive mode DB 16, which are examples of storage units in the present invention, may be implemented using independent means in FIG. 2, they all may be represented by a single storage unit, such as a memory, etc.

Moreover, since the second device 20 includes a wired communication unit 21, a connection detection unit 22, a wireless communication unit 23, an information storage unit 24, a transmit mode DB 25, a receive mode DB 26, and a display unit 27 provided with the same features as the units in the first device 10, detailed explanations of the units are omitted.

Its operation is explained below.

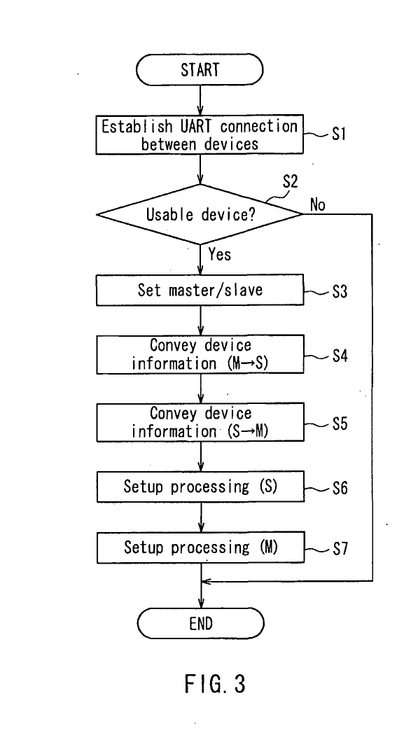

FIG. 3 illustrates the sequence of operation of the information communication system of the present embodiment. First of all, when the audio system 1 and portable audio device 2 are not yet paired for wireless communication with each other, the portable audio device 2 (second device 20) is inserted into the slot 3, as shown by the dashed arrow in FIG. 1, thereby interconnecting the wired communication unit 11 of the audio system 1 and wired communication unit 21 of the portable audio device 2. The connection detection unit 12 detects the connection between the wired communication units 11 and 21. The detection results are forwarded to the control unit 18. On the other hand, in the second device 20, the connection detection unit 22 also detects the connection between the wired communication unit 21 and wired communication unit 11. The detection results are forwarded to the control unit 28 (S1).

It should be noted that in the present embodiment the portable audio device 2 is driven by a built-in battery and, at the same time, the audio system 1 is provided with a feature for battery charging by inserting the portable audio device 2 into the slot 3. According to the conventional manner of use, when one starts using the portable audio device 2, battery charging has to be performed by inserting it into the slot 3 of the audio system 1. By arranging the processing illustrated in FIG. 3 to start at this time, the charging of the battery of the portable audio device 2 and the information exchange intended for wireless communication between the two devices can be carried out simultaneously. The user's ease of use can be improved because the information exchange process intended for wireless communication is performed without conscious effort. Moreover, the processing illustrated in FIG. 3 is effective not only during the initial use of the portable audio device 2, but also when pairing the audio system 1 and portable audio device 2 in a state, in which the audio system 1 has been paired with another device. It should be noted that this explanation refers to a case in which the portable audio device 2 is a chargeable device, and when this device that does not require charging, both devices need to be connected by wired in order to carry out the information exchange intended for wireless communication between the two devices.

Moreover, information on the connected devices can be arranged to be displayed in the topmost portion of the list displayed on the display units 17 and 27 whenever two devices are connected by wired. When lists comprising information on multiple devices are displayed on the display units 17 and 27, this enables the user immediately to select the devices connected by wired at that particular time and allows for the ease of use to be improved.

Next, the control unit 18 makes a determination as to whether the second device 20 is a device that can be controlled by the first device 10. If the results of the determination show that the second device 20 is a device that does not permit pairing based on a wired connection between the wired communication units 11 and 21 (device not adapted for Bluetooth communication), the process is stopped (S2).

Next, if the results of the determination process performed in S2 show that the second device 20 is a controllable device, the control unit 18 configures the first device 10 and the second device 20 as a master/slave. Methods used for master/slave configuration include, for example, a method, in which the model types of the two devices are read and compared, with the device having a smaller model type set up as a master. In the present embodiment, it is assumed that the first device 10 is configured as a master and the second device 20 is configured as a slave. It should be noted that the terms “master” and “slave” refer not to the terms master/slave as used in Bluetooth communications, but to the terms master/slave as used in wired communications (S3).

Next, device information is transferred from the first device 10, i.e. the master device, to the second device 20, i.e. the slave device. Specifically, the control unit 18 reads the information related to the first device 10 stored in the information storage unit 14 and transfers it to the second device 20 via the wired communication unit 11 and pathway 31. It should be noted that, in the drawings, the letter “M” designates a master and the letter “S” designates a slave (S4).

Here, the service information, device information, link keys, and address information, etc. associated with the first device 10 are stored in the information storage unit 14. Although the control unit 18 may transfer all of these information items to the second device 20, only a portion of the information comprising at least the address information may be arranged to be transferred. If all of the above-mentioned information items are arranged to be transferred, the first device 10 and the second device 20 can be transitioned to a state in which they can communicate wirelessly with each other, and, at the same time, information related to the second device 20 (device name, service name, etc.) can be displayed on the display unit 17 and information related to the first device 10 can be displayed on the display unit 27.

It should be noted that if only address information is arranged to be transferred when the first device 10 is set into transmit mode and the second device 20 is set into receive mode, shared link keys are pre-stored in the transmit mode DB 15 of the first device 10 and receive mode DB 25 of the second device 20 in advance. Moreover, when the first device 10 is set into receive mode and the second device 20 is set into transmit mode, the link keys are pre-stored in the receive mode DB 16 of the first device 10 and transmit mode DB 26 of the second device 20. This makes it possible to perform mutual authentication of devices based only on exchanging address information. This can be done easily if, for example, the first device 10 and the second device 20 are manufactured by the same manufacturer. Moreover, only the address information and link keys may be arranged to be transferred. This permits easy mutual device authentication.

Next, the control unit 28 reads the information related to the second device 20 that is stored in the information storage unit 24 in advance. The control unit 28 transfers the information that has been read to the first device 10 via the wired communication unit 21 and pathway 31 (S5).

Next, the second device 20 outputs the information concerning the first device 10 received via the wired communication unit 21 to the control unit 28. The control unit 28 stores the information concerning the first device 10 in the transmit mode DB 25 and receive mode DB 26. The process of storing information transferred from other devices in this manner is referred to as “setup processing” (S6).

Next, the first device 10 outputs the information concerning the second device 20 received via the wired communication unit 11 to the control unit 18. The control unit 18 performs setup processing, which involves storing the information concerning the second device 20 in the transmit mode DB 15 and receive mode DB 16 (S7).

As a result of the above-described process, the information related to the second device 20 is stored in the databases 15 and 16 in the first device 10 while the information related to the first device 10 is stored in the databases 25 and 26 in the second device 20, i.e. information is exchanged between the two devices.

By completing the information exchange in this manner, the devices accomplish authentication information exchange and are placed into a state, in which they can communicate wirelessly with each other. When the first device 10 and the second device 20 are transitioned into their respective wireless communication modes or when the two devices are powered up in this state, the control unit 18 reads the information concerning the second device 20 from the databases 15 and 16 and, at the same time, the control unit 28 reads the information concerning the first device 10 from the databases 25 and 26. As a result, the control unit 18 recognizes at least the address information concerning the second device 20 and control unit 28 recognizes at least the address information concerning the first device 10. Thus, the first device 10 and the second device 20 are placed into a state, in which they can establish Bluetooth-based wireless communication through the wireless communication units 13 and 23.

During the second and subsequent connections between the first device 10 and the second device 20, the first device 10 refers to the transmit mode DB 15 and receive mode DB 16 and the second device 20 refers to the transmit mode DB 25 and receive mode DB 26. As a result, the first device 10 and the second device 20 can be placed into a state permitting wireless communication.

It should be noted that while in the explanations provided above the first device 10 was connected as the transmitter side (in transmit mode) and the second device 20 was connected as the receiver side (in receive mode), the same components, processing and operation may be used for connection when the first device 10 is connected as the receiver side (in receive mode) and the second device 20 is connected as the transmitter side (in transmit mode).

In the present embodiment, the first device 10 and the second device 20 are arranged to be connected by wired and exchange device information with each other. As a result, the first device 10 and the second device 20 can be placed into a state permitting Bluetooth-based wireless communication between the two even without performing the pairing process required in the Bluetooth communication system. Accordingly, the user can enable Bluetooth-based wireless communication simply by inserting the portable audio device 2, i.e. the second device 20, into the slot 3 in the audio system 1, i.e. the first device 10. Thus, burdensome setup operations are rendered unnecessary, which allows operability to be improved.

Moreover, since operations intended for device selection and passkey entry operations are rendered unnecessary, setup operations involved in device authentication can be simplified.

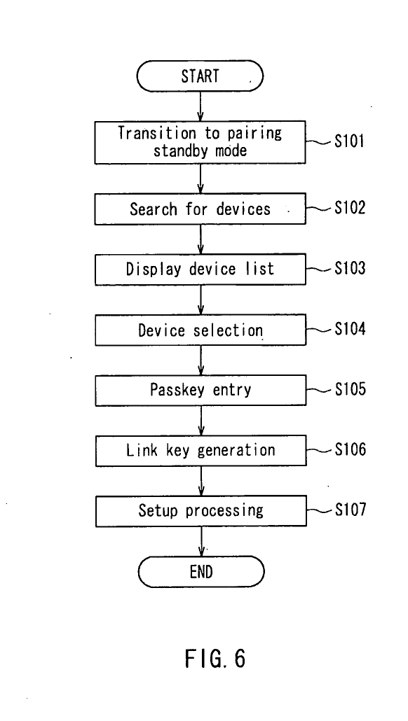

Moreover, since the Bluetooth pairing process illustrated in FIG. 6 is not performed, the time to completion of device authentication can be shortened, which allows the ease of use to be improved. Specifically, in the Bluetooth pairing process, approximately 2-3 minutes are required from the start of authentication until its completion. By contrast, in the present embodiment, the authentication process is completed within a few seconds.

Moreover, since service information and device name information are arranged to be transmitted, display of service names and device names on the display units 17 and 27 is made possible along with permitting user identification of devices available for connection and easy classification of devices in case there are numerous devices listed.

It should be noted that processing is not limited to the procedure illustrated in FIG. 3 and may be arranged to be performed in the order of Steps S5, S4, S7 and S6. Moreover, processing may be arranged to be performed in the order of Steps S5, S4, S6 and S7. Furthermore, processing may be arranged to be performed in the order of Steps S4, S5, S7 and S6. In addition, the processing of Steps S6 and S7 may be arranged to be performed simultaneously.

Moreover, Bluetooth-based wireless connections may be arranged to be prohibited while the processing illustrated in FIG. 3 is executed. This permits prevention of mismatches between the contents of the lists and actual device connection status.

Moreover, the link keys generated in transmit mode may be made different from the link keys generated in receive mode. Below, Table 3 illustrates the contents of the transmit mode DB 15, which stores a list of receiving devices in the first device 10. Table 4 illustrates the contents of the receive mode DB 16, which stores a list of transmitting devices in the first device 10. Table 5 illustrates the contents of the transmit mode DB 25, which stores a list of receiving devices in the second device 20. Table 6 illustrates the contents of the receive mode DB 26, which stores a list of transmitting devices in the second device 20.

TABLE 3
Transmit Mode DB of First Device

| Address | Link Key |
|---|---|
| ADD_{PAD} | Lα |

TABLE 4
Receive Mode DB of First Device

| Address | Link Key |
|---|---|
| ADD_{PAD} | Lβ |

TABLE 5
Transmit Mode DB of Second Device

| Address | Link Key |
|---|---|
| ADD_{MINI} | Lβ |

TABLE 6
Receive Mode DB of Second Device

| Address | Link Key |
|---|---|
| ADD_{MINI} | Lα |

If the first device 10 is in transmit mode and the second device 20 is in receive mode during pairing via the wired communication units 11 and 21, the address information ADD_{PAD} and link key Lα of the second device 20 are stored in the transmit mode DB 15 as shown in Table 3 and the address information ADD_{MINI} and link key Lα of the first device 10 are stored in the receive mode DB 26 as shown in Table 6. Moreover, if the first device 10 is in receive mode and the second device 20 is in transmit mode, the address information ADD_{PAD} and link key Lβ of the second device 20 are stored in the receive mode DB 16 as shown in Table 4 and the address information ADD_{MINI} and link key Lβ of the first device 10 are stored in the transmit mode DB 25 as shown in Table 5. In other words, when the first device 10 is in transmit mode, the same link key is stored in the transmit mode DB 15 and receive mode DB 26, and when the second device 20 is in transmit mode, the same link key is stored in the receive mode DB 16 and transmit mode DB 25.

Although the link key Lα and link key Lβ may be fixed values, they may be arranged to be obtained via computation based on the address information; in addition, unique random codes generated in each device may be arranged to be exchanged between the devices, with the link key Lα and link key Lβ obtained via computation in each device.

Moreover, although the explanations above referred to configurations, in which the first device 10 and the second device 20 both had a transmit mode and a receive mode, either one of the devices may have only a transmit mode or only a receive mode. In such a case, the device that has only one mode is provided with only one database, i.e. either a transmit mode DB or a receive mode DB. Moreover, the device connected to the device having only one mode (i.e. the device that has both modes) stores information concerning the device having only one mode in either one of its transmit mode DB or receive mode DB.

### EMBODIMENT 2

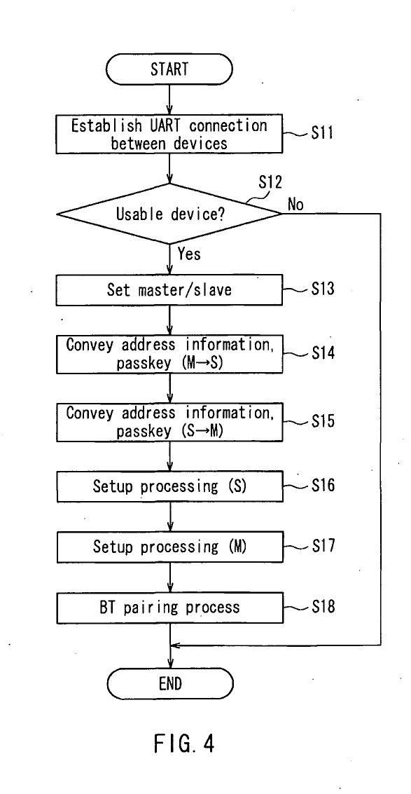

FIG. 4 illustrates the sequence of processing in an information communication device used in a second embodiment. In FIG. 4, the processing involved in Steps S11-S13 is the same as the processing involved in Steps S1-S3 of FIG. 3, but the processing of Step S14 and the subsequent steps is different from the sequence of processing illustrated in FIG. 3. The processing of Step S14 and the subsequent steps are explained below. It should be noted that the sequence of processing illustrated in FIG. 4 can be implemented in the configuration illustrated in FIG. 1 and FIG. 2.

In FIG. 4, the first device 10, i.e. the master device, transfers address information and a passkey to the second device 20, i.e. the slave device. Specifically, the control unit 18 reads the address information and passkey of the first device 10 stored in the information storage unit 14 and transfers it to the wired communication unit 21 of the second device 20 via the wired communication unit 11 and pathway 31. Although in the past the passkey used to be entered by the user, in the present embodiment, it is assumed to be stored in the information storage unit 14 in advance (S14).

Next, the control unit 28 reads the address information and passkey of the second device 20 stored in the information storage unit 24 and transfers it to the wired communication unit 11 via the wired communication unit 21 and pathway 31 (S15).

Subsequently, the control unit 28 performs setup processing, which involves storing the passkey and address information of the first device 10 transferred by the wired communication unit 21 in the information storage unit 24 (S16).

After that, the control unit 18 performs setup processing, which involves storing the passkey and address information of the second device 20 transferred by the wired communication unit 11 in the information storage unit 13 (S17).

Next, a Bluetooth pairing process is executed on the first device 10 and the second device 20 (S18). Specifically, while the process illustrated in FIG. 6 is executed, the passkey entry process (S105), which required the user to perform entry operations, is rendered unnecessary because in the present configuration the control unit 18 reads out the passkey stored in the information storage unit 14. More specifically, the control unit 18 reads out the passkey from the information storage unit 14 and generates a link key and the control unit 28 generates a link key based on the passkey obtained from the first device 10. Since the passkey used for link key generation in the control units 18 and 28 is the same, the link keys generated in Step S106 are the same as well.

Since the process of entering passkeys (S105), which was required in the past, is rendered unnecessary, this configuration permits a reduction in the number of entry operations by the user and allows for operability to be improved.

Although in this configuration the process of passkey entry by the user is rendered unnecessary, it should be noted that passkeys may be entered for the purpose ensuring security. In such a configuration, the time to pairing authentication may be made considerably shorter than in the past.

The present invention is useful in information communication devices capable of Bluetooth-based and other wireless communication. It is particularly useful in devices comprising wired communication element in addition to wireless communication element. The information communication device of the present invention can be applied to systems permitting wireless communication between talking devices that combine, for instance, a mobile phone handset with earphones and a microphone, or to systems permitting wireless communication between automotive audio systems and portable audio devices.

What is claimed is:

1. An information communication device, comprising:
a wireless communication unit capable of wireless communication with another information communication device via short-range wireless communication;
a wired communication unit capable of wired communication with the other information communication device;
a storage unit that stores first device information and second device information, the first device information is transferred from the other information communication device via the wired communication unit, and the second device information is concerning this device; and
a control unit that controls all the units,
wherein the control unit,
upon connection of the wired communication unit to the other information communication device, reads the second device information from the storage unit and control to transfer the second device information to the other information communication device via the wired communication unit, and control to store the first device information transferred via the wired communication unit from the other information communication device in the storage unit, and
when wireless communication is effected using the wireless communication unit, performs communication connection authentication based on the first device information stored in the storage unit.

2. The information communication device according to claim 1, wherein the first device information and the second device information include at least address information used for wireless communication between the devices.

3. The information communication device according to claim 1, wherein the first device information and the second device information include device address information and information required for link key generation.
